(19) United States
(12) Patent Application Publication
(10) Pub. No.: US 2004/0052526 A1
(43) Pub. Date: Mar. 18, 2004

(54) Connection optimization and control in agile networks

(76) Inventors: Kevan Peter Jones, Kanata (CA); Mark Stephen Wight, Ottawa (CA); Hock Gin Lim, Green Brook, NJ (US); Paul Edward Beer, Nepean (CA); Clarence Kwok-Yan Kan, Bridgewater, NJ (US); Aihua Yu, Ottawa (CA); Sheldon Walklin, Kanata (CA); Jingyu Zhou, Morganville, NJ (US); Paul Po-Wan Chan, Ottawa (CA); David Andrew Whittaker, Nepean (CA); Kinh Minh Pham, Nepean (CA); Robert M. Kimball, Lanoka Harbor, NJ (US); Christian Scheerer, Ottawa (CA); Alan Glen Solheim, Stittsville (CA)

Correspondence Address: Atten: Norman P. Soloway, HAYES SOLOWAY P.C., 130 W. Cushing Street, Tucson, AZ, 85701, US

(21) Appl. No.: 10/244,928

(22) Filed: Sep. 16, 2002

(51) Int. Cl. H04J 14/02

(52) U.S. Cl. 398/50; 398/195

(57) ABSTRACT

An agile network is provided with a layered control system for maintaining a network-wide target performance parameter (e.g. power) along all end-to-end connections. A connection is controlled at the physical layer using optical control loops that have a concatenated response based on a set of loop time constants. The network is separated into gain based span loops and power based switch loops; each link has a gain profile, and requires a per-wavelength power target as the output power target for the switch loop at the start of the link. Use of achievable gain for the span loops allow to optimize the performance of the link. Use of individual achievable power targets allows each switch loop to autonomously ramp on and off channels without causing interference with existing and other ramping channels. A loop control uses a model-based rules block, to distribute control signals to an optical section encompassing a plurality of optical components. Results from a set of tests performed during link commissioning are used as parameters for the expert system. After examining the current status of the entire optical section and collecting a set of measurements, the rules block determines the best way to achieve the target, whilst maximizing performance. Use of an embedded expert system enables to perform accurate real time performance estimation. Use of a model for all optical sections allows a level of abstraction at the loop boundaries, such that changes can be made independently. A device template is used for all optical devices in the network. The template defines the control and monitoring points for the respective device and specifies the type, range, and points to the device constants. With each iteration, the model and the current optical path measurements are used to adjust the optical path settings and update the model.

### PRIORITY PATENT APPLICATIONS

U.S. patent application “Architectures for a wavelength switching node of a photonic network” (Solheim et al) Ser. No. 10/114,781 filed Apr. 3, 2002 and assigned to Innovance Inc., docket 1002US.

U.S. patent application “Line Amplification System for Wavelength Switched optical Networks” (Jones et al) Ser. No. 09/975,362, filed Oct. 11, 2001 and assigned to Innovance Inc., docket 1004US.

U.S. patent application “Architecture for an OADM node of a WDM optical Network” (Roorda et al) Ser. No. 10/002,773, filed Nov. 2, 2001 and assigned to Innovance Inc., docket 1006US.

### RELATED PATENT APPLICATIONS

U.S. patent application “Method for Engineering Connections in a Dynamically Reconfigurable Photonic Switched Network” (Zhou et al.), Ser. No. ______ not received yet, filed May 31, 2002 and assigned to Innovance Inc., docket 1010US, which is incorporated herein be reference.

### FIELD OF THE INVENTION

The invention is directed to a telecommunication network, and in particular to connection optimization and control in agile photonic networks.

### BACKGROUND OF THE INVENTION

Current transport networks are based on a WDM (wavelength division multiplexing) physical layer, using point-to-point (pt-pt) connectivity. The flexibility (agility) of the current network comes at the expense of cost and scalability; i.e. network flexibility is delivered electronically, and thus requires termination of photonic layer at each node. 65-70% of nodal optical-electrical-optical (OEO) conversion is for managed passthrough, or so called ‘hidden regenerators’. A networking solution that eliminates these hidden regenerators will be far less expensive to deploy.

Also, with a conventional point-to-point dense WDM (DWDM) system, turning-up a single communication channel (a wavelength) across a network may take months due to the complexity of point-to-point wavelength engineering process. This time and effort is an impediment to service velocity and a tax on operations.

The ULR (ultra long reach) and OADM (optical add/drop) technologies address partly these problems. Thus, ULR extended the distance a wavelength may travel without electrical regeneration. OADM enables now optical bypass of selected channels and also enables access (add/drop of channels) at intermediate nodes.

However, these technologies require additional flexibility to allow automatic routing of channels from any source to any destination over a mesh connected WDM layer. Emerging of tunable optical components such as tunable lasers and filters and transparent switching hardware make an agile photonic network feasible. The agile network architecture must enable full end-to-end connectivity across a mesh WDM layer, real-time engineering of end-to-end connections, automatic routing and wavelength assignment, automatic channel set-up and reconfiguration. Thus, the conventional pt-pt based DWDM transport boundaries disappear in this architecture and are replaced by individual wavelength channels going on-ramp and off-ramp at arbitrary network nodes.

By removing OEO conversion for the passthru channels at the switching nodes, connection set-up and control become significant physical design challenges. Traditional channel performance optimization methods do not apply to end-to-end connections that pass through many nodes without OEO conversion. Furthermore, traditional section-by-section equalization cannot be performed; connections sharing a given fiber section now have substantially different noise and distortion impairments, determined by their network traversing history.

There is a need to provide dynamic line and switch control system capable of adding and removing mesh-routed end-to-end wavelengths connections without impacting the existing traffic.

### SUMMARY OF THE INVENTION

It is an object of the invention to provide an agile photonic network with an optical control system for ensuring a performance level over the lifetime of a given network connection, in the presence of network reconfiguration and other churn in the physical layer.

According to an aspect of the invention, an agile optical network is provided with an optical control loop for operating an end-to-end trail established across the network, comprising: an optical section including a group of optical devices provided along said trail for performing a specific operation on an optical signal; an external adaptive loop for receiving a current measured value [M] of a loop parameter and providing an adjust signal adj; and a rules block for distributing said adjust signal as specific control signals [C] to each respective optical device of said group for maintaining said loop parameter into a specified range of values.

The invention also provides a control system for engineering connections in a photonic switched network of the type having a plurality of wavelength cross-connects WXC connected by links, the control system comprising: a plurality of control loops, each for monitoring and controlling a group of optical devices, according to a set of loop rules; a plurality of optical link controllers, each for monitoring and controlling operation of said control loops provided along a link; a plurality of optical vertex controllers, each for monitoring and controlling operation of said control loops provided at a wavelength cross-connect; and a network connection controller for constructing a data communication path within said photonic switched network and for monitoring and controlling operation of said optical link controller and said optical vertex controller.

According to still another aspect, the invention is concerned with a control system for engineering connections in a photonic switched network having a plurality of wavelength cross-connects WXC connected by links, the control system comprising: a plurality of control loops, each for monitoring and controlling a group of optical devices, according to a set of loop rules; and an engineering tool for receiving measurement data and information on said control loop state from each said control loop, importing information on said control loop model from a performance and monitoring database, and providing said control loop with a range for the input signal and a target for the output signal.

A method of controlling the performance of an optical path established over an agile optical network, comprises, according to a still further aspect of the invention, providing a predefined power per channel mask based on a model of said optical path; measuring an input and an output optical power for each channel traveling along said optical path; and adjusting the power profile of said channels according to said masks.

Advantageously, the invention provides end-to-end path performance control and optimization based on current network connectivity information and measured physical performance parameters of each optical path, which leads to significant up-front and lifecycle network cost savings. Use of current network connectivity information and measured performance parameters of the path confers better accuracy of network operations control. Also, by moving away from the traditional worst case based engineering rules, the overall network design and cost can be significantly optimized.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 shows a fragment of an agile network according to the invention for defining some terms used in this specification;

FIG. 2A is a block diagram of the control system of the agile network of FIG. 1;

FIG. 2B shows the flow of information between the optical devices, the connection control system and the network operating system;

FIG. 3 shows an optical gain control loop;

FIG. 4A shows a block diagram of a vector optical control loop according to the invention;

FIG. 4B shows the optical device model;

FIG. 5 shows an example of a vector optical gain loop used in the agile network of FIG. 1;

FIGS. 6A to 6C show examples of span loops, where FIG. 6A shows a DGMA span loop, FIG. 6B shows a MA span loop and FIG. 6C shows a composite span loop;

FIG. 7 shows an example of a vector optical power loop used in the agile network of FIG. 1;

FIGS. 8A and 8B provide examples of power loops, where FIG. 8A shows the power loops at a switch node, and FIG. 8B shows the power loops at an OADM node; and

FIG. 9 shows by way of example the optical control loops for a connection between two consecutive switching nodes.

### DESCRIPTION OF PREFERRED EMBODIMENTS

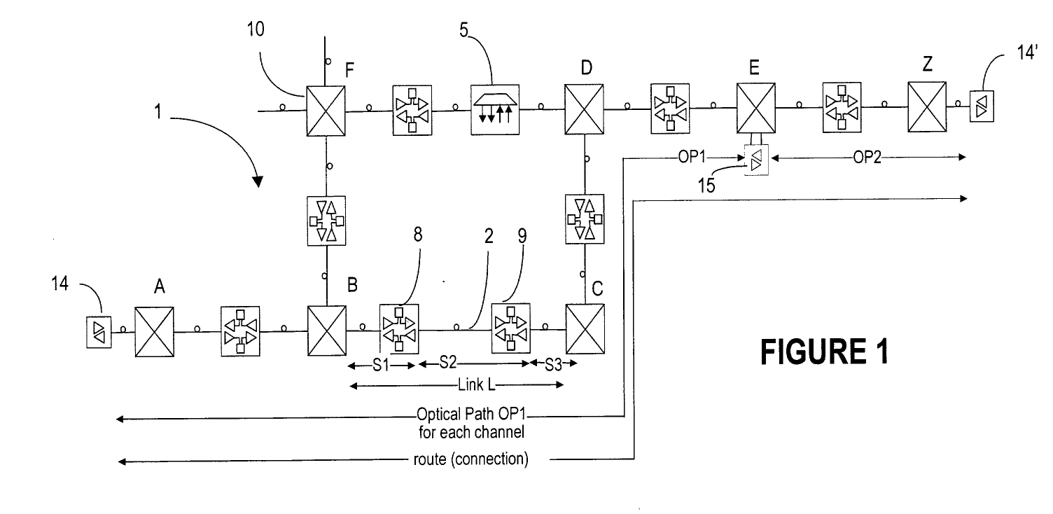

FIG. 1 illustrates a fragment of an agile network 1 for defining some terms used in this specification. The term ‘switch’, or ‘switching node’, or ‘flexibility point’ refers to a node A, B, C, D, E, F or Z of network 1, which is equipped with a wavelength switch 10. An nxm wavelength switch has n input ports and m output ports for routing the traffic from an input port to any output port. Switch 10 is also generally equipped with add and drop ports for allowing on ramp and off ramp of user traffic.

The term ‘connection’ refers here to a logical path which can be set-up along a plurality of end-to-end physical trails (routes, paths). For example, an AZ connection transporting traffic between a transponder 14 at node A and a transponder 14′ at node Z, can be established along an end-to-end trail A-B-C-DE-Z, or along an alternative end-to-end trail A-B-F-D-E-Z.

The term ‘optical path’ refers to the portion of a connection between a transmitter and the next receiver; the user traffic is carried along the optical path on a certain optical channel. The term ‘channel’ is used to define a carrier signal of a certain wavelength modulated with an information signal.

An end-to-end trail assigned to a connection may have one or more successive ‘optical paths’, using regenerators at the ends of the optical paths for wavelength conversion or signal conditioning as/if needed. In the example of FIG. 1, the end-to-end route A-B-C-D-E-Z has two successive optical paths. A first path OP1 originates at node A, passes through node B and C and ends at node D. A second path and OP2 connects nodes D and Z. A regenerator 15 is used at node D for conditioning the user traffic, or for changing the carrier wavelength.

The term ‘link’ is used for the portion of the network between two successive flexibility sites, such as link L shown between nodes B and C. The term ‘section’ or ‘span’ refers to the portion of the network 1 between two optical amplifiers. For example, span S2 includes the fiber 2 between the output of amplifier 8 and input of amplifier 9 and the equipment making-up the amplifier 9. Link L has three spans, denoted with S1, S2 and S3.

FIG. 1 also shows an OADM node 5. Unlike a wavelength switching node, an OADM has only one input port and one output port; its role is to separate the input multi-channel (WDM) received on the input port into drop channels and passthrough channels, and direct the drop channels to the local user(s). The OADM also combines the passthrough channels on the output port with the add channels received from the local client(s) into an output WDM signal.

As discussed above, in traditional WDM systems, all wavelengths originate at one node and propagate together down the fiber to the next location, where the optical layer is terminated. This simplifies the line design since all the wavelengths have approximately the same distortion, noise and see the same dispersion. On the other hand, in network 1 there is no such start and stop location for all the wavelengths. One wavelength may originate locally, while the next from a thousand kilometers to the East and the next from 2000 km to the North, etc. No assumptions can be made about the OSNR or distortion/dispersion history of adjacent wavelengths being similar. Furthermore, wavelengths need to be added and dropped at each flexibility site with a minimal impact on co-propagating channels. Therefore, the optical layer for network 1 requires a different design approach than the traditional WDM networks.

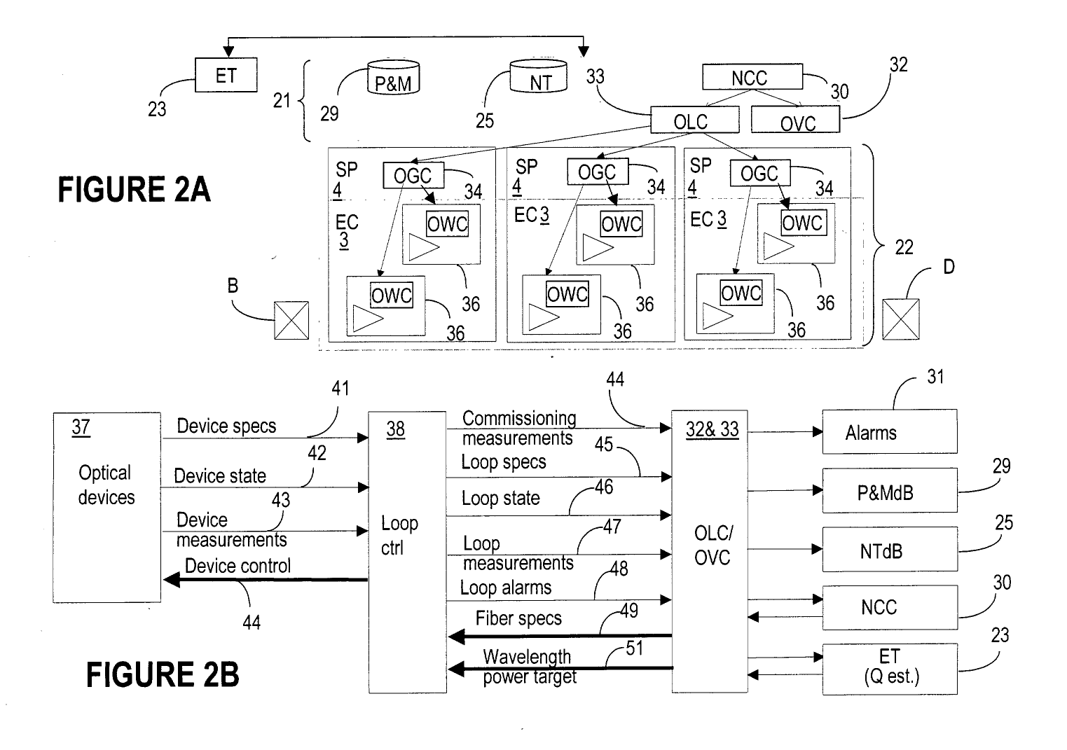

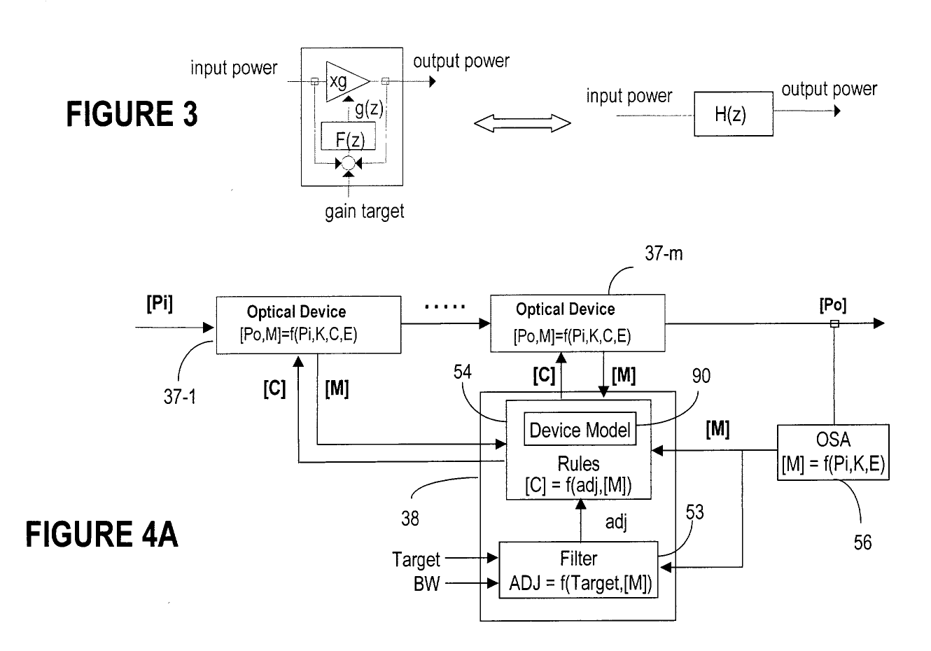

The optical modules of network 1 are controlled using the entities shown in FIG. 2A.

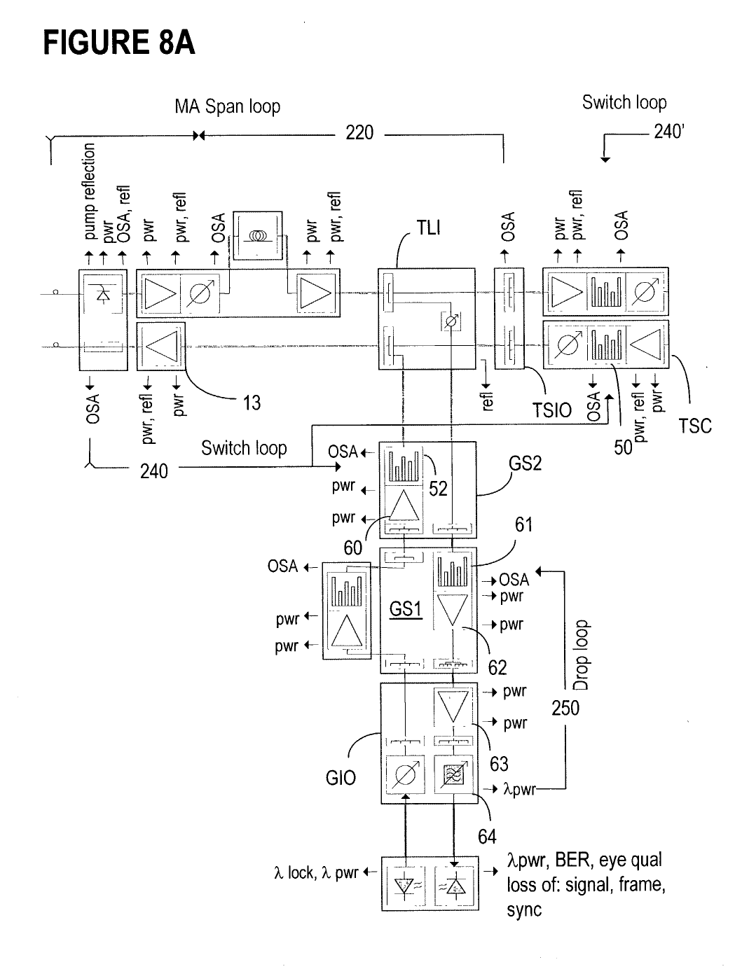

As described in the above identified co-pending patent application docket 1010P, operation and control in network 1 are layered. Relevant to this invention are the control entities at the connection management layer 21 and the control entities at the physical (optical layer) 22. To enable automatic connection set-up and removal, the agile network is provided at the physical (optical) layer with an embedded platform 22 that performs optical module performance monitoring and control. There are two levels of control at this platform, the card-pack (module) level and the shelf level. Most card-packs in the agile network 1 use a standard card 60 (see FIG. 7A) equipped with an embedded controller EC 3 and with the respective optical module(s) that make the card specific. All shelves are provided on a standard backplane equipped with a shelf processor 4 and the respective card-packs that make the shelf specific. The shelf processor SP 4 and the ECs 3 are connected over a backplane data communication network.

The agile network uses an optical supervisory channel OSC (not shown) for transmitting signaling and control data between platforms 21 and 22 and also for monitoring the integrity of the line system over bidirectional links. All service information necessary for proper operation of the line system (optical amplifiers and OADMs) and switches is transported between the sites on this channel. The OSC is preferably a POS (packet over SONET) that operates at OC-3 rate, embedded on the WDM fiber over a wavelength of 1510 nm. The OSC is coupled/decoupled at the optical amplifier modules; the SPs at the ends of a link are provided with packet routing capabilities.

The optical modules are also connected over an optical trace channel OTC (not shown) that follows all the fiber connections between the optical components along each possible path within network 1, so that the network operating system may perform path selection based on this information. This connectivity information is stored/updated in a network topology database 25. Also, a performance and monitoring database 29 stores updated performance data regarding the optical modules, along with user-defined thresholds for these parameters and other operation, administration, maintenance and provisioning data. Databases 25 and 29 are shown separately based on the type of information they maintain. In fact, topology and performance data are stored in the MIB (management information base) at various processing platforms and a distributed topology system (not shown) enables various entities to access this information.

Network 1 is also equipped with an engineering tool ET (for example a Q estimator) 23, which estimates the performance of the optical path necessary for route selection. Namely, selection of end-to-end trail A-B-C-D-E-Z over end-to-end trail A-B-F-D-E-Z (see FIG. 1) for the A-Z connection is determined based on the estimated Q of these routes calculated by ET 23. The Q estimator 23 requires a set of parameters from each optical component, per wavelength power measurement in various points throughout the network, and a set of fiber parameters. This information is made available in the database 29.

FIG. 2A shows at the lowest level of control, namely at the embedded module layer, optical widget controllers OWC 36 that provide the interfaces to the various optical modules that make-up the network 1. They reside on the respective ECs 3 to set the control targets for the optical modules, read run-time data and intercept asynchronous events. The OWC has a generalized interface to the optical module, and the vendor specific details are contained within the device drivers. OWCs are provided for example for the EDFAs (Erbium doped fiber amplifiers), Raman amplifiers, DGEs (dynamic gain equalizers), OSAs (optical spectrum analyzers), tunable filters (TF), VOA (variable optical attenuators), transmitters (Tx), receivers (Rx) and wavelength blockers (B).

The optical group controllers OGC 34 reside on a respective SP 4 and coordinate the actions of various optical devices in the shelf. For example, in the case of an optical line amplifier, the group includes a Raman card-pack, an EDFA card-pack with mid-stage access, a DGE (dynamic gain equalizer) and a DCM (dispersion compensation module). These modules are operated as a group by the OGC 34, to achieve a control objective for the group as a whole.

At the trail management level 21, an optical link controller OLC 33 is responsible with all control activities that fall within the scope of a link (the fiber and associated amplifier group(s) between two flexibility points). The Specifically, OLC 33 is responsible for commissioning and certifying a link, re-provisioning OGCs 32 as required following power cycles and certain restart scenarios, link channel quality testing, periodic link channel monitoring. It is also responsible with line system topology discovery and channel provisioning. Also, OLC 33 distributes the power targets to the span control loops during link commissioning, and consolidates and stores link information in database 29.

Commissioning the link implies applying initial startup control targets to all OGCs in the link, and running an iterative distributed algorithm to optimize the link performance. Certifying the link implies connecting a transmitter/receiver at each end of the link and cycling through all supported wavelengths to ensure that the quality of each wavelength is at an in-service level. In any restart/recovery scenario in which the OGC 32 is unable to recover its provisioned control targets locally, it is up to the OLC 33 to re-provision those targets.

Link channel quality testing is performed for example during light-path setup, when the quality of each channel is measured at the ends of each link to ensure that their performance exceeds a pre-defined margin. The pre-defined margin consists of a system margin and a wavelength-loading margin. Details on these margins and how path monitoring and maintenance are performed are provided in the above-referenced U.S. patent application Docket 1010US.

An optical vertex controller OVC 32 is provided at the switching nodes, being responsible for connection and power control through the respective switch 10. Connection and control of regenerators and wavelength translators at that node falls within the scope of the OVC. The OVC 32 also provides default values for some loop control constants, consolidates WXC/OADM information and stores it in the database 29.

NCC 30 provides the type of the actual connection (e.g. connect through, connect a regenerator, connect access and connect a receiver) and accomplishes the end-to-end path set-up by coordinating activities of various OVCs 32 and OLCs 33 along the end-to-end trail. NCC also distributes the loop time constants.

FIG. 2B shows the flow of information between the entities in FIG. 2A. There are three levels of control shown generically on FIG. 2B, namely the loop level control, the OLC/OVC level control and the network management level control.

The control loops are provided for setting and maintaining the parameters of the network optical devices within the operational ranges, so that the network is unconditionally stable. The loops sample the signal at given intervals and compare the samples with performance targets. It is a design requirement that steady state operation of the control loops optimizes the network for maximum reach. Maximum reach could be for example summarized as the minimum total number of network regenerators. As well, the loops are designed so that channel adds and drops do not affect existing add and passthrough channels at all nodes in the respective connection.

The contribution of control loop to channel add time is minimized by adaptive ramp rates based on the number of active and ramping-on channels. The channel add time is further improved by use of prediction of ramping-on and adjacent channel-to-channel interaction. One to ninety-nine channels can be added to a link simultaneously in any combination of through and add channels.

Generically, an optical control loop encompasses an optical device 37 (or an optical path). A loop control 38 receives information such as device specifications [K, E] 41, device states 42, device measurements [M] 43 from various optical modules connected in the respective loop. The loop control 38 uses this information to control the device(s), by sending device control information [C] 44. An example of a device control [C] is the gain target for an optical line amplifier.

An example of device specifications [K] are gain and attenuation range for a wavelength cross-connect.

Each loop has a set of faults that the loop control 38 can identify directly. A set of thresholds defines a degraded and a failed state for optical device 37. Loop control 38 also identifies when a component setting is at, or near a limit. For example, it can detect an ‘approaching maximum pump power’ event. In some cases loop control 38 can also identify when a component ‘fails to respond’.

Device measurements [M] are obtained from various manufacturer-provided monitoring points, where a PIN diode converts a fraction of the optical signal diverted by a tap into an electrical signal, for power and reflection monitoring.

At the next level, an OLC (optical link controller) 33 manages one or more span loop. It receives loop turn-up measurements 44, loop specification information 45, loop state information 46, loop measurements 47 and loop alarms 48. In addition the loop state 46 and measurements 47 are available to a fault diagnostic unit (not shown), which allows determining the nature of the fault. The span loop requires for example fiber type and wavelength power targets, so that the OLC 33 sends control information 49 and 51 to the respective loop control 38. The OVC (optical vertex controller) 32 controls the switch and drop loops (described later), that require wavelength power targets.

Examples of commissioning measurements are Raman gain, path loss, and module specifications (such as e.g. maximum DCM power) for all the amplifiers in the link. In response, the OLC 32 sends control signals 52 such as link gain distribution, launch power range.

Examples of loop state information is the number of active channels, gain degradation, pump power usage. In response, the OLC 32 sends control signals such as requests to modify link gain distribution and available launch power.

Loop specifications are for example loop maximum output power, loop gain, etc. Loop alarms are for example failure to meet the target.

At the network management control level, the OLC/OVCs transmit alarm information shown at 31, supply performance and monitoring data to database 29, and supply topology data to topology database 25. Alarm diagnostics 31 can put a wavelength into open loop mode in order to perform tests.

OLC 33 and OVC 32 are controlled by the NCC 30 and by engineering tool 23.

Types of Loops Controlling Operation of the Physical Layer of Network 1

1. Optical components, which are not part of a control loop are managed by an open loop driver. The open loop driver is responsible for setting the component to its default value, alarming and reporting device information. For example, the laser turn-on is open ended.

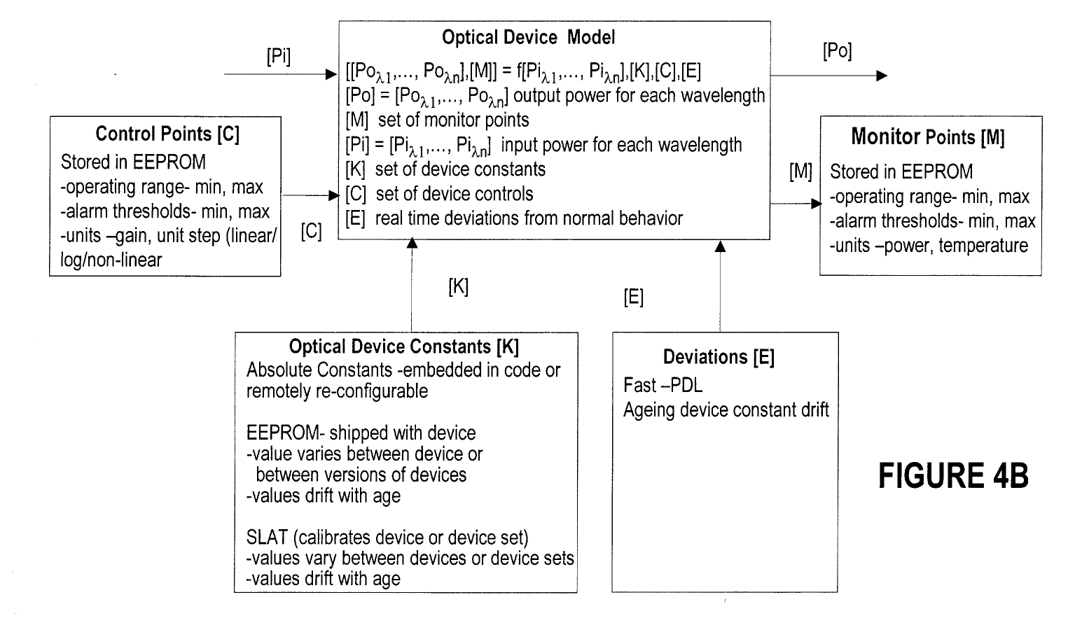

2. Gain loops. FIG. 3 shows a gain loop, which is used for example by the EDFA modules of the line amplifiers, pre amplifiers and postamplifiers. The gain loops used in network 1 use input and output powers measured by the input and output power monitors available on commercial EDFA modules, and a gain target based on the total power (the power of all channels). The measured gain is compared against the gain target and the pump currents are adjusted accordingly. The loop characteristics could be for example the bandwidth and the input and output slew rate. The gain control signal is calculated such that the loop behaves as a linear time invariant (LTI) system.

3. Vector loops.

A vector loop has a gain or power target for a plurality ‘n’ of channels, but does not operate as a set of ‘n’ independent loops. The error signal generated is a vector with ‘n’ elements. The loop seeks to minimize the energy of the error vector.

The vector loops used in network 1 have the following main characteristics:

Use of the real-time measurements for determining the loop control signals. Agile network 1 is provided with a plurality of optical spectral analyzers OSA, which enable visibility of per-wavelength signal power level and noise level in pre-selected monitoring points. Each OSA module is preferably time-shared so that it collects performance data from a plurality of monitoring points (e.g. 8).

Application of a model-based rules block (expert system) to a distributed system encompassing an optical section made of a plurality of optical components. After examining the current status of the entire optical section and the new measurements, and based on the model, the rules block determines the best way to achieve the new target, whilst maximizing performance. In addition, use of a model-based expert system allows maximizing loop performance, and also allows enhancements and further intelligence to be added without directly impacting the stability of the loop. (i.e. the loop response can be changed without modifying the model and in general the expert system).

Use of an embedded expert system to perform accurate real time performance estimation. In this way, the expert system may use adaptive and predictive techniques.

Use of a model for all optical sections to allow a level of abstraction at the loop boundaries, such that changes can be made independently. At the lowest level, a device template is used for all optical devices in the network. The template defines the control and monitoring points for the respective device and specifies the type, range, and points to the device constants. With each iteration, the model and the current optical path measurements are used to adjust the optical path settings and update the model. The model is updated with specific, condensed and extrapolated data.

Use of an external adaptive loop (the loop filter) to manage the expert system and compensate for inaccuracies in the model and the model data. In addition, the gain loop uses a simple predictive model of the expert system tilt ripple and gain limits in the external adaptive loop. This predictive model contains the error excursions and presents the expert system with a solvable target.

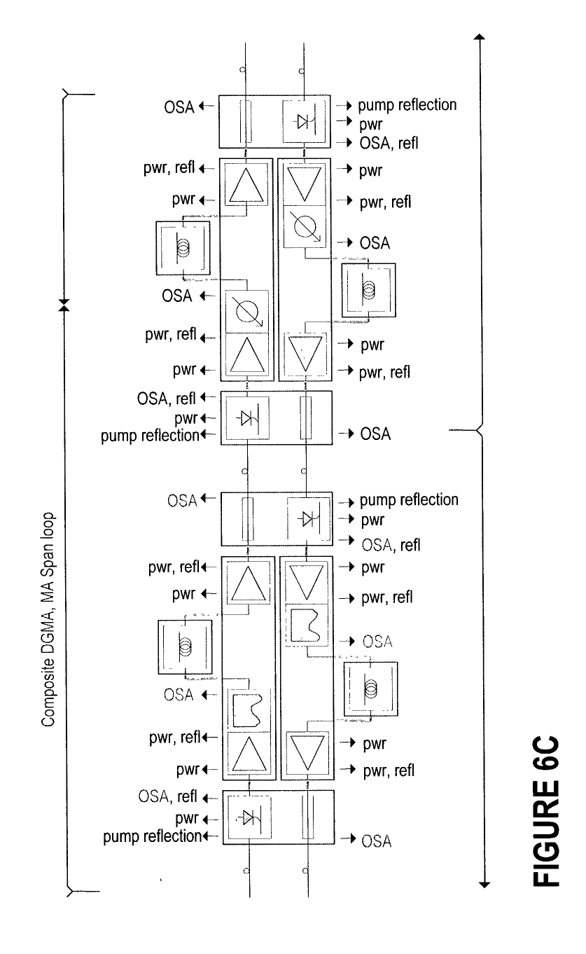

Separation of network into gain based span loops (FIG. 5) and power based switch loops (FIG. 7). In a sequence of span loops the loop responses do not concatenate because the loop, to meet its gain target, responds only to perturbations originating within the scope of the loop. The switch loops have individual channel control using blockers (see FIG. 7). Each end-to-end channel has a concatenated response based on a set of loop time constants which are calculated as a function of the number of sequential switch loops in the connection.

A set of tests is performed during link commissioning. The test results are used as parameters for the expert system. A variation of the expert system is then used to predict the fully loaded operation of the link and to distribute achievable gain/power targets to each span/switch loop. Use of achievable gain for the span loops allow to optimize the performance of the link. Pre-emphasis is used to compensate for the limitations of downstream loops. Use of individual achievable power targets allows each switch loop to autonomously ramp on and off channels without causing interference with existing and other ramping channels.

The arrival of a stimulus signal at each loop initiates a loop response according to the loop transfer function H(z). A difference in input and output sampling times can couple an unwanted ‘common mode’ component into the loop response. The coupling coefficient is small if the time difference is small relative to the period of the maximum frequency component of the signal.

Signals can propagate transparently through control loops. Transparent propagation creates a situation where many loops can see a stimulus but only one must respond. Signals generated by loop responses branch and converge. The interaction of control loops must create the intended network response to changes, and maintain stability during steady state operation. For example, when routing a path through multiple switches 10 and links L, the launch power, the gains of the switches and the link gain need to be compatible. This is achieved with a network wide standard, using unity gain or a per optical channel serial construction.

Loop interaction is designed to allocate the network response to the appropriate set of loops and in the correct order, using a coupling coefficient. Unwanted loop interaction has a low coupling coefficient. The bandwidth and order of interacting loops are selected as a tradeoff between minimum excursion error and maximum response. The response of a loop is also chosen to be compatible with the sampling rate of a downstream (or outer) loop.

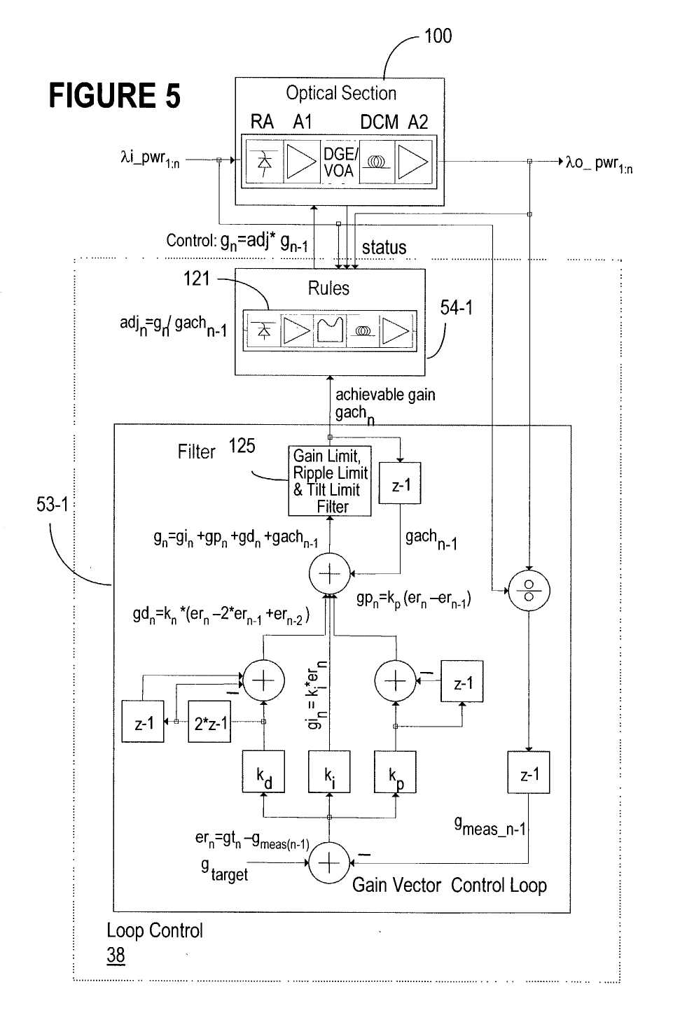

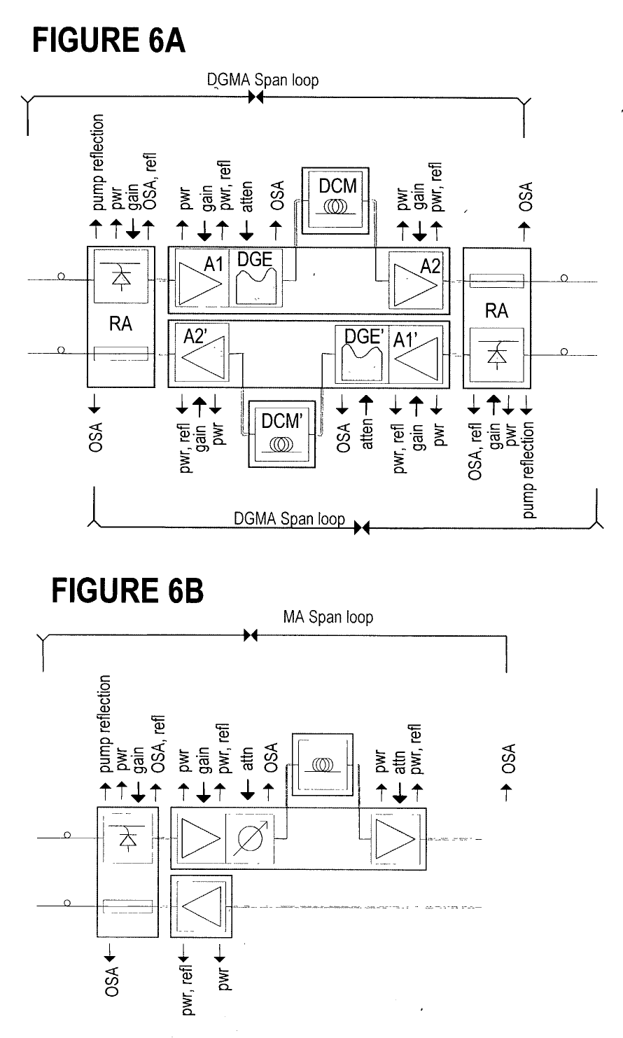

FIG. 4A shows the block diagram of optical vector control loop with rules, which encompasses devices 37-1 to 37-m. In general, the loop control 38 comprises an external adaptive loop (filter) 53 and a model-based expert system (rules block) 54.

The device is represented by a power transfer function (i.e. the output power over the input power):

[[Po_{λl}, . . . , Po_{λn}], [M]]=f([Pi_{λl}, . . . , Pi_{λn}], [K], [C], [E])

where [Po]=[Po_{λl}, . . . , Po_{λn}] is the output power for each wavelength, [Pi]=[Pi_{λl}, . . . , Pi_{λn}] is the input power for each wavelength, [M] is a set of monitoring points, [K] is a set of device constants, [C] is a set of device controls and [E] accounts for real time deviations from the normal behavior.

A loop operates based on per-wavelength targets distributed during channel set-up. The loop filter 53 compares the target with a measured like-parameter and provides the loop error, namely an ‘adj’ signal to the rules block 54.

The transfer characteristic of the rules block is:

[C]=f[adj, M]

In other words, the control signal for each optical device 37-1 to 37-m is obtained by distributing the respective measured parameters based on the ‘adj’ signal.

As indicated above, the rules block 54 is an expert system, which uses a model (template) 90, which is updated with specific, condensed and extrapolated data with each iteration. Rules block 54 can be instructed to initialize the loop model and the devices. This block can also be instructed to add/remove a wavelength. Control of a wavelength, which is not in the set of added wavelengths, remains static. A static wavelength does not generate an error signal for the loop filter and its measurements are not used in the rules calculation. Active traffic can run on static wavelengths. Channel setup uses this technique to ramp the wavelength power before adding it to the loop. Block 54 also generates fault points.

As indicated above, a plurality of OSA modules 56 are distributed throughput network 1 to measures transmitter power, blocker attenuation per wavelength, amplifier gain per wavelength, etc. for the respective input power and the current set of device constants.

[M]=f(Pi,K,E)

These measurements are used along with their history and the current state of the loop to determine the best set of actions to correct the loop error. Fault monitoring also rely on this information to localize failures in the network.

FIG. 4B shows the optical device model, also indicating examples of type and address for monitoring points, control points and constants.

The monitor points [M] are stored in the device EEPROM and provide the operating ranges (minimum and maximum), alarm thresholds ranges, and the units of measurement for the respective parameter (power, temperature).

Control points [C] are also stored in the device EEPROM and provide the control range, the alarm range and the measurement units, including the scale (linear, logarithmic, non-linear). The optical device constants [K] are classified in absolute constants, EEPROM constants and SLAT (system start-up and test) constants. The absolute constants are embedded in code or remotely configurable. The EEPROM constants are shipped with the device and have values that vary between devices, or between versions of the device. The SLAT constants calibrate the device or a group of devices and have values that vary between devices or device sets, or drift with device age.

The deviations [E] could be for example fast parameters for the PDL (proportional and derivative) and the device constant drift (ageing).

FIGS. 5 and 7 show examples of control loops with rules used in network 1. As shown in FIG. 4A, these loops control a respective optical path using a model-based rules block and a loop filter. The example illustrated in FIG. 5 shows a gain loop with rules, and the example in FIG. 7 shows a power loop with rules.

The span loop shown in FIG. 5 is a gain loop with rules, which includes the optical section 100 and loop control 38. The optical section 100 encompasses the fiber span 2 between the upstream amplifier and the input of the optical amplifier under consideration, a Raman module RA, a first EDFA stage A1 and a second EDFA stage A2. A dispersion compensating module DCM is preferable connected between the two stages A1 and A2 for compensating for the dispersion introduced by the fiber along the respective span. A VOA (variable optical attenuator) or a dynamic gain equalizer DGE is also preferably provided in the mid-stage for conditioning the signal. Other configurations are equally possible.

The loop control is designed with an external adaptive loop 53-1 and a rules block 54-1.

As described in connection with FIG. 4A, the control rules block 54-1 is preferably implemented as an expert system, using a model 121 of the respective optical section, which encompasses a respective span in this case. The model 121 is designed using a plurality of measurements obtained during system installation and testing, current measurements, constants from engineering tool 23 (see FIG. 1B), constants from components, design constants, status and operating range of each mode, alarm conditions. A combination of default and device-EEPROM values are used to determine the initial loop state. As indicated above, the model and the control signals are updated with the latest measurements.

The rules block 54-1 receives the input and output measurements and the current status of the entire span, and uses the model 121 for allocating individual controls to each module for adjusting the performance of the individual channels in the optical path 100.

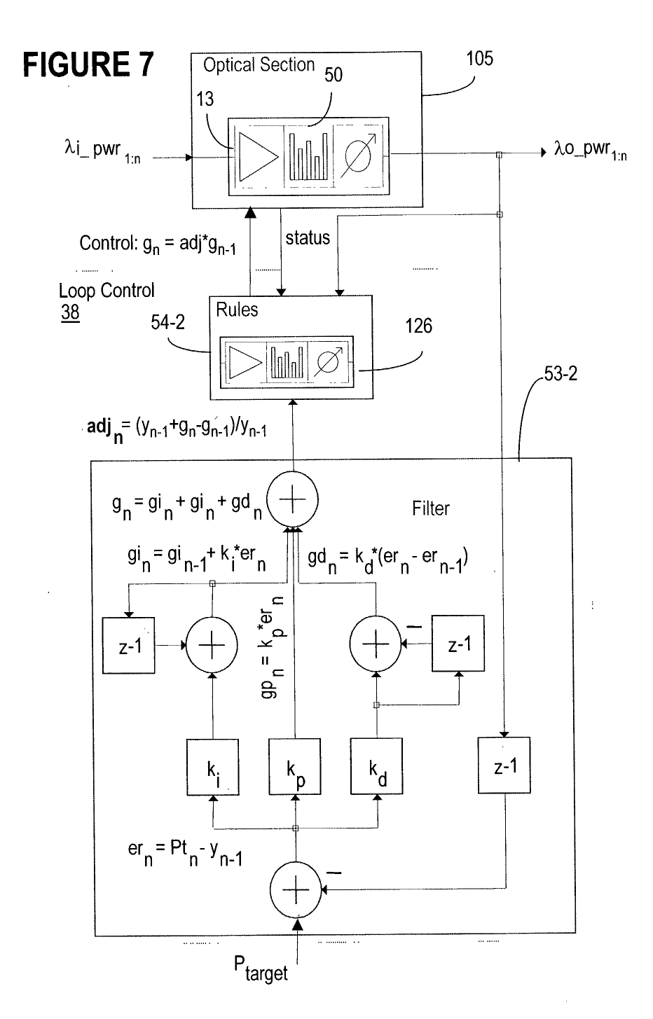

The status data is derived from the device data, device settings, and several OSA and pin measurements, as shown in more detail in FIGS. 6A and 6B. Allocation of span loop states to each channel (not present, partially present, present) is used to gradually introduce/remove the participation of a channel to/from the loop expert system loop calculations as its power is ramped on or off. Partially present is a fuzzy variable whose value measures the degree of membership in the ‘on’ and ‘off’ states. A gradual transition to/from ‘on’ state prevents interference with existing and other ramping channels.

Span loops make simultaneous spectral measurements at the input and output of the loop and separate total power measurements within the loop. Measurements are made after the previous cycle adjustments have settled. Input-output power/channel sampling λᵢpwr_{1.n}−λoᵢpwr_{1:n} with a gain target g_{target} confines the loop to respond to changes within its own domain and reduces or eliminates the interaction with adjacent loops. In service modifications of the gain profile are possible with the requirement that existing channels are not degraded and the loops are not significantly perturbed. In service modifications might be made to compensate for aging or to optimize reach based on the connection profile.

Loop filter 53-1 compares the output power and the input power (which is the launch power of the previous amplifier) against a per wavelength gain target g_{target} to generate an error signal erₙ=gtn−gₘₑₐₛ₍ₙ₋₁₎ as a new target. Since this is a vector gain loop, the loop has a target for a plurality ‘n’ of controlled entities, to control the gain for various stages of the optical section 100. The error signal generated is a vector with ‘n’ elements, and the loop seeks to minimize the energy of the error vector. The loop filter 53-1 uses loop constants kᵢ, kₚ and k_{d} (the integral, proportional and derivative constants) calculated using a function based on the number of OADMs and WXCs in the optical path and the position of the loop in the sequence of loops, to achieve the following objectives:

Minimize PDL noise gain

Minimize tracking error, overshoot, undershoot

Spatially distribute simultaneous response

Identical response for 2-16 sequential loops

Identical add loop response.

Constants kᵢ, kₚ and k_{d} and filters z⁻¹ are used to specify the a gain vector gₙ as a function of the integral, proportional and derivative gains and also of the achievable gains, as follows:

giₙ=kᵢ×erₙ

gpₙ=kₚ(erₙ−erₙ₋₁)

gdₙ=kᵢ(erₙ−2erₙ₋₁+erₙ₋₂)

gₙ=giₙ+gpₙ+gdₙ+gachₙ₋₁

As the measurement data include spectral power information measured by OSA unit 56 (see FIG. 4A), the loop filter is able to perform spectral power equalization by compensating for amplifier ripple/tilt, systematic de/multiplexing, loss variation, spectral variations in the loss of the transmission fiber and/or dispersion compensation elements. A simple predictive model (gain, ripple, tilt limit filter) 125 provides the achievable gain based on the loop constants.

The output of filter 53-1 is the achievable gain gachₙ, which depends on the current gain gₙ and the past (n−1) achievable gains. Rules block 54-1 receives the “gachₙ” signal and calculates an “adjₙ” vector of n adjust signals:

$${adj}_{n} = \frac{{g}_{n}}{{g}_{ach\_n - 1}}$$

The adj signal in this case is implicit in the gₙ and is used to distribute the gain between the optical devices of section 100, as a function of the present and past gains:

gₙ=adj·gₙ₋₁

In summary, after examining the current status of the entire optical section and the new measurements and based on model 121, the rules block 54-1 determines the best way to achieve the new target, whilst maximizing performance. The control signal adjusts accordingly the current of the Raman pump RA, the target gain of the EDFA stages A1 and A2, and the attenuation of the VOA, or the attenuation of the gain-flattening module DGE.

FIGS. 6A to 6C show the types of optical paths for the span loops used in network 1. Thus, a DGMA (dynamic gain control mid-stage amplifier) span loop uses optical amplifiers equipped with a dynamic gain equalizer DGE as shown in FIG. 6A, and a MA (mid-stage amplifier) span loop uses optical amplifiers equipped with a variable optical attenuator VOA as shown in FIG. 6B. A link may be built with combinations of MAs and DGMAs, which are controlled by a composite span loop as shown in FIG. 6C. A MA is preferred for the preamplifier configuration (at the input of a flexibility or OADM site) since it is less expensive and also since gain flattening is inherently performed by other units present at such sites. Also, in shorter links with fewer optical amplifiers between the flexibility sites, it is possible to reduce the number of DGMAs by using MAs; it may also be possible to eliminate the DGMAs entirely. Details on the optical amplifier configurations are provided in the above-reference patent application Docket 1004.

The OSC carrying the service information for the optical amplifiers along a link is decoupled from the forward fiber and coupled over the reverse fiber by a respective WDM splitter at the RA module. In fact, the output WDM signal on a reverse line is passed through the Raman modules for the reverse direction for taking advantage of the access to the OSC provided on this unit. The bidirectional OSC is passed from the RA module to the shelf network processor 4 (loop control 38) using a transmitter/receiver pair.

The DGMA shown in FIG. 6A is equipped with a Raman module RA and an EDFA module. The EDFA module includes two amplification stages A1 and A2, with a gain flattening module DGE and a dispersion compensation module DCM connected between stages A1 and A2 to ensure that an optimal power profile is maintained along the line. The DCM provides advanced fiber-based slope-matched dispersion compensation. Adjustable (tunable) DCMs can also be used in some instances.

Raman module provides access to OSA for both Westbound and Eastbound directions for the total input and output powers. This module provides for example the Raman output power and receives a Raman gain control signal; the gain can be fixed, but is preferably not: a fixed gain limits the application of the hardware configuration to a small range of fiber losses, because of the gain tilt induced in the EDFAs in the line. The model predicts the signal-to-signal SRS (stimulated Raman scattering) gain and predicts the estimated Raman gain. The rules block controls the Raman gain.

The flexible control of the Raman gain enabled by use of model 121 may importantly optimize the link performance. For example, the Raman gain may be actively tilted by changing the ratio between the power of the pumps. In this way, by equalizing and minimizing the noise over the entire transmission band, the OSNR performance is optimized. As well, if the Raman gain is increased above the conventional operating point and a red gain tilt is forced at the EDFA, a better isolation between the L and C bands may be obtained.

Other optimizations are described in above-identified co-pending patent application Docket #1004US.

The EDFA stages A1 and A2 provide power and reflection measurements. The model estimates the EDFA gain and set the new gain according to the measurements and the target.

An OSA measurement at the output of the DGE provides the spectral power measurement after the EDFA stage A1 to enable determining the control signal for the DGE, taking also into account the new gain for the EDFA stages.

The MA of FIG. 6B is also equipped with two amplification stages A1 and A2 and a dispersion compensation module DCM connected between stages A1 and A2. As indicated above, this amplifier uses a VOA rather than a DGE and therefore a total attenuation control rather than a per-wavelength attenuation control. In other words, this loop is not able to adjust the spectrum of the WDM signal.

A link between two flexibility sites may have more than one span; the rules block allows extending the concept of ‘span’ to ‘super-span’, controlled by a composite span loop as shown in FIG. 6C. The composite span loop encapsulates a first type span loop, one or more second type loops, and a respective OSA 56 for providing power and spectrum measurements at the site of the DGMA. Preferably, a MA is controlled from the site of a DGMA. This allows operation of the composite loops in the event that some OSA measurements are not available (failed OSA), since the rules block of a DGMA is able to interpolate the spectra at a failed OSA at the upstream DGMA. In this case, the composite loop control that has access to the OSA measurement overtakes control of two successive composite loops. This extension of control to the next available working site allows the control system to continue operation with some reduced accuracy, while providing a very robust system overall.

Each link has a gain profile; the gain profile default is unity. An optimized gain profile can be derived using the link measurements during system line-up and test (SLAT). Each span loop uses part of the link gain profile as its gain target.

Although the loop targets are set during network installation, they are adjusted by a slow background loop to eliminate residual errors. The span loop residual power targets are derived from the launch power into the link and the link gain profile up to the target point. A residual power loop comprising a low frequency integrating filter placed between the output of the loop and the input of block 53-1, receives the input power target for the respective span, and adjusts the loop gain target in response to deviations from the output power. The residual power loops in a wavelength path are connected in series. The gain target adjustment range is however limited. While the span loop is able to correct a slow ripple of deviations along the wavelength axis (this is a DGE limitation), fast ripple and per wavelength perturbations are corrected by the switch loop.

Agile network 1 also uses three types of power loops, namely a WXC switch loop at a switching node, a OADM switch loop at an OADM node, and a drop loop at all nodes that have an access drop stage. The above-referenced patent application Docket 1002 provides details on switch configurations and Docket 1006 provides details on OADM configurations.

Each link of network 1 requires a per-wavelength power target as the output power target for the switch loop at the start of a link. Launch power targets and switch loop gain constants are delivered to each switch loop for each wavelength as part of connection setup. Each optical path has a progression of switch loop responses. The last loop has the fastest response.

FIG. 7 shows a vector power loop with rules. This loop performs only output per-channel power sampling. The optical section 105 encompasses in general a blocker 50 and an optical amplifier 13. A blocker is an optical device that allows a group of wavelength to pass through while blocking other wavelengths. The wavelengths in each group need not be consecutive and can be changed in software. The blocker is used to allow or block channels to pass through a node or to be dropped to a certain client. Since in an agile network the connections are dynamically set-up and removed, the blocker transfer characteristic changes accordingly. As before, the loop control 38 is designed with an external adaptive loop 53-2 and a rules block 54-3. The loop filter 53-2 determines the size of the adjustment in response to the loop error. The loop error is the difference between a power target and the measured output power for each channel.

erₙ=Ptₙ−yₙ₋₁

where Pt is the target power and y is the power at the output of the optical path.

The loop filter 53-2 is designed to respond as a low pass filter in the frequency domain, with the integral proportional and derivative constants kᵢ, kₚ and k_{d} selected to meet the step response requirements. In the time domain, the filter is designed to respond as a high pass filter, with the time constant chosen to balance the requirement to minimize gain at high frequencies and to compensate for low frequency PDL. The power loop constants kᵢ, kₚ and k_{d} are specific for each wavelength and connection stage. Distribution of loop constants or loop order is performed during channel set-up. The loop constants determine the proportional, integral and derivative gains, as follows:

giₙ=giₙ₋₁+kⱼ×erₙ

gPₙ=kₚ×erₙ

gdₙ=k_{d}(erₙ−erₙ₋₁)

and the current gain:

gₙ=giₙ+gpₙ+gdₙ

The output of the loop filter 53-2 is an adjust signal ‘adj ’ which depends on the current gain gₙ and the past gain gₙ₋₁.

$${adj}_{n} = \frac{{y}_{n - 1} + {g}_{n} - {g}_{n - 1}}{{y}_{n - 1}}$$

Rules block 54-2 distributes the adjustment as per-channel gain and attenuation to the respective optical components 50, 13 encompassed by the loop, based on a model 126 of the optical section 105 using the ‘adj’ signal, Switch loop states (off, clamp, ramp on, active, freeze, ramp off) are allocated to each channel, along with a state machine defining state transitions and transition triggers. The channel states are used such that each switch loop can autonomously ramp on and off channels without causing interference with existing and other ramping channels.

The gain control signal is calculated such that the loop shown in FIG. 7 approximates a linear behavior:

gₙ=adj×gₙ₋₁

The optical devices of section 105 perform the respective gain.

As in the case of the gain loop, the power loop response can be changed without modifying the model 126 and in general the rule block 54-2. First order loop interaction will also remain the same. Alternatively, the rules can be changed without redesign of the loop. This degree of freedom includes the addition of optical components.

The add, through and drop power loop responses are concatenated. Each optical path is a different concatenation. Through loops protect against upstream failures by clamping when a channel disappears and ramping it when it returns.

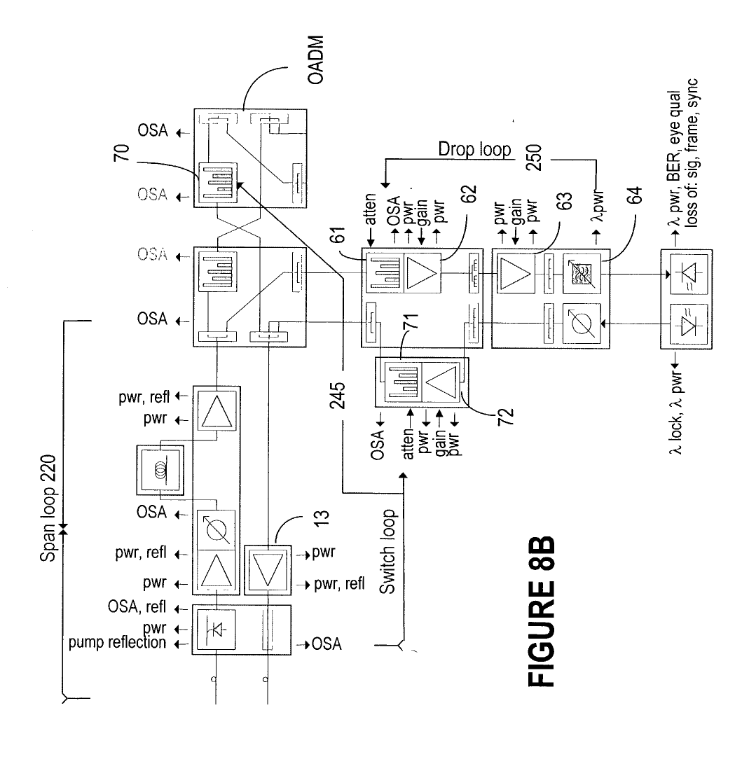

FIG. 8A illustrates the control loops at a wavelength switching node, namely a MA span loop 220, a switch loop 240 and a drop loop 250. This figure also shows the measurements provided by the optical devices encompassed by the respective loop. OSA measurements are constantly performed at a preset rate per wavelength sweep. These measurements are used along with their history and the current state of the loop to determine the best set of actions to correct the loop error.

This switch loop 24 shown for the West-East direction, encompasses the components of a terminal line interface TLI module, tandem switch input/output TSIO module, the tandem switch core TSC module, the add side of gateway stage-2 (access) GS2 module, and postamplifier 13. Details on the operation of a power loop are provided in FIG. 8B and the corresponding description in the co-pending U.S. patent application Ser. No. 10/002,773, docket 1006, identified above.

The switch loop uses a power target for each passthrough and added wavelength, chosen to fit into the range limits defined by the gain profile of each link of the optical path, and by the gain-attenuation range of the TSCs. Thus, the loop adjusts the set-up of blocker 50, and the EDFA gain target for postamplifier 13 in response to a deviation from the power of a passthrough channel. For an add channel, the setting of blocker 52 and gain target for amplet 60 of module GS2 are adjusted according to the power target. The loop is designed so that there is no wavelength interaction. The switch loops interact sequentially along each channel path (connection), according to rules and the number of loops in the respective optical path.

FIG. 8A also shows a drop loop 250. The drop loop encompasses the components of the drop access structure and is controlled as a power loop with a power target for each dropped channel. The optical section includes the blocker 61 and amplet 62 of module GSI, and amplet 63 and the tunable filter 64 of module GIO. In this embodiment, in response to a deviation from the power target, the blocker settings are adjusted with feedback from the power monitor of the tunable filter 64. The tunable filter 64 has a coarse (without signal) and a fine (with signal) tuning phase.

FIG. 8B illustrates the control loops at an OADM node, namely a MA span loop 220, a switch loop 245 and a drop loop 250. The switch loop uses a power target for each passthrough and added wavelength, chosen to fit into the range limits defined by the each link's gain profile and each OADM gain-attenuation range. Thus, the loop adjusts the set-up of blocker 70 and the EDFA gain target for postamplifier 13′ in response to a deviation from the power of a passthrough channel. For an add channel, the setting of blocker 71 and EDFA gain target of amplet 72 are adjusted according to the power target. As before, the loop is designed so that there is no wavelength interaction. The switch loops interact sequentially along each channel path (connection).

FIG. 8A also shows a drop loop 240 which is similar to that in FIG. 8A; the WXC and OADM drop loops are identical.

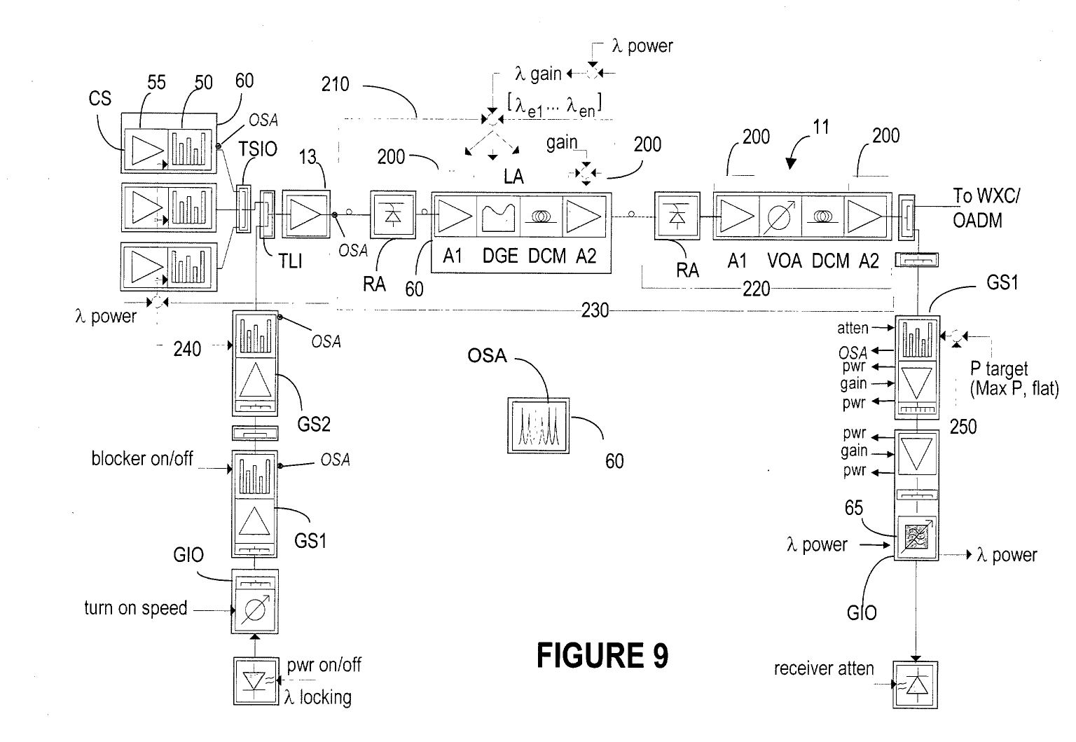

FIG. 9 shows an example of the optical control loops that operate optical path between two successive switching nodes. It illustrates gain loops such as an EDFA gain loop 200, DGMA span loop 210, MA span loop 220, and a concatenated span loop 230. It also shows power loops such as WXC switch loop 240 and drop loop 250. FIG. 9 also shows the optical modules, OSA monitor points and the targets for the loops.

An example of the arrangement of the optical modules on the card-packs is also shown; the card-packs are generically designated with reference numeral 60. Thus, in case of an optical amplifier, card 60 is equipped with a first and second EDFA module A1 and A2, a VOA or a DGE module, and subtends a DCM module. In the case of a core switch module CS, card 60 houses an amplet 55 and a blocker 50. The switch also uses splitter/combiners modules (TLI terminal line interface and TSIO tandem switch input/output) connected between the core switch CS modules and the postamplifier 13.

For the WXC switch loop, all wavelengths output by a postamplifier 13 are controlled by the same loop 240. The OSA monitor output of the postamplifier is subtracted from the power target to generate an error vector for the loop filter 532 (see FIG. 7). The rules block 54-2 uses the filter output, the component calibration information and the remaining monitor outputs to generate the control inputs.

We claim:

1. An optical control loop for operating an end-to-end trail established across an agile optical network, comprising:
an optical section including a group of optical devices provided along said trail for performing a specific operation on an optical signal;
an external adaptive loop for receiving a current measured value [M] of a loop parameter and providing an adjust signal adj; and
a rules block for distributing said adjust signal as specific control signals [C] to each respective optical device of said group for maintaining said loop parameter into a specified range of values.

2. An optical control loop as claimed in claim 1, wherein said external adaptive loop has a filter transfer function adj=f(target, [M]).

3. An optical control loop as claimed in claim 1, wherein said rules block is an expert system with a rules block transfer characteristic [C]=f(adj, [M]).

4. An optical control loop as claimed in claim 3, wherein said expert system includes a model of said optical section, reproducing the current behavior of said optical devices.

5. An optical control loop as claimed in claim 4, wherein said loop parameter is measured at preset intervals of time, to update [M] and said model is updated accordingly.

6. An optical control loop as claimed in claim 5, wherein said model is further updated with current measured device operational parameters.

7. An optical control loop as claimed in claim 6, wherein said current measured value is the output power of said optical signal at the output of said optical section.

8. An optical control loop as claimed in claim 6, wherein said external adaptive loop and said rules block also receive a current measured value for the input power of said optical signal at the input of said optical section.

9. An optical control loop as claimed in claim 1, wherein said current measured value is obtained from an on-line measurement device shared between a number of measurement points.

10. An optical control loop as claimed in claim 4, wherein the device transfer function of each said optical device is [Po, M]=f(Pi, K, C), where
Pi is the input power and Po is the output power for a transmission channel λₙ present in said optical signal,
M is said current measured value of said loop parameter,
K is an optical device constant, and
C is said specific control signal.

11. An optical control loop as claimed in claim 10, wherein said output power is also a function of real time deviations of said K.

12. An optical control loop as claimed in claim 10, wherein said model is changed whenever a corresponding device in said optical section is changed, without modifying said rules block.

13. An optical control loop as claimed in claim 10, wherein said rules block is modified without changing said model.

14. An optical control loop as claimed in claim 10, wherein said model is provided with a memory for storing information regarding the location of a measurement point for said current measured value of said loop parameter, the measurement units, operating range and alarm thresholds.

15. An optical control loop as claimed in claim 10, wherein said model is provided with a memory for storing information indicating the location of a control point for said specific control signal, the measurement units, operating range and alarm thresholds.

16. An optical control loop as claimed in claim 10, wherein said device constant is provided by said optical device, being pre-stored in a device memory at manufacture or stored in said device memory during system commissioning.

17. An optical control loop as claimed in claim 1, wherein each said optical device comprises an embedded controller for receiving said specific control signal and adjusting an operational parameter of said optical device accordingly.

18. A control system for engineering connections in a photonic switched network of the type having a plurality of wavelength cross-connects WXC connected by links comprising:
a plurality of control loops, each for monitoring and controlling a group of optical devices, according to a set of loop rules;
a plurality of optical link controllers, each for monitoring and controlling operation of said control loops provided along a link;
a plurality of optical vertex controllers, each for monitoring and controlling operation of said control loops provided at a wavelength cross-connect; and
a network connection controller for constructing a data communication path within said photonic switched network and for monitoring and controlling operation of said optical link controller and said optical vertex controller.

19. A control system as in claim 18, wherein each said control loop receives specifications, state and measurements information from all optical devices of said group and controls operation of each said device according to preset operational parameters.

20. A control system as in claim 18, wherein said optical link controller receives specifications, state and measurements information from all said control loops and controls said control loops based on optical path specifications.

21. A method as claimed in claim 20, wherein said loop control specifications include fiber specifications information and power targets.

22. A method as claimed in claim 18, wherein said optical link controller further receives loop turn-up measurements and loop alarms.

23. A control system as claimed in claim 18, wherein said control loops are one of a gain loop and a power loop.

24. A control system as claimed in claim 23, wherein said gain loop operates comparing a current gain measurement with a gain target, said current gain measurement being derived from input and output power sampling.

25. A control system as in claim 23, wherein said gain loop is a vector gain loop that operates using ‘n’ current gain measurements with an n-dimensional target.

26. A control system as claimed in claim 18, wherein each said control loop operates in a transparent propagation mode and a response mode.

27. A control system as claimed in claim 26, wherein said control loops interact based on a coupling coefficient, wherein said coefficient is selected so as to allocate the response of said coupled loops to the appropriate set of loops and in the correct order.

28. A control system for engineering connections in a photonic switched network having a plurality of wavelength cross-connects WXC connected by links, said control system comprising:
a plurality of control loops, each for monitoring and controlling a group of optical devices, according to a set of loop rules; and
an engineering tool for receiving measurement data and information on said control loop state from each said control loop, importing information on said control loop model from a performance and monitoring database, and providing said control loop with a range for the input signal and a target for the output signal.

29. A method of controlling the performance of an optical path established over an agile optical network, comprising:
providing a predefined power per channel mask based on a model of said optical path;
measuring an input and an output optical power for each channel traveling along said optical path; and
adjusting the power profile of said channels according to said masks.
